(19) United States
(12) Patent Application Publication
(10) Pub. No.: US 2009/0227199 A1
(43) Pub. Date: Sep. 10, 2009

(54) DEVICE AND METHOD FOR PREVENTING UMTS MOBILE DEVICES FROM ACCESSING A NETWORK

(75) Inventors: Aaron S. Madsen, Mt. Prospect, IL (US); Michael L. Johnson, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/045,272

(22) Filed: Mar. 10, 2008

(51) Int. Cl. H04K 3/00

(52) U.S. Cl. 455/1

(57) ABSTRACT

An interference system and method of interfering with signals from a Universal Mobile Telecommunications System (UMTS) mobile device in a particular area are disclosed. The mobile device receives an access grant from a UMTS base station. The mobile device transmits a response to the base station. An interference device in the same area as the mobile device also receives the access grant and sends a corruption signal that interferes with the response to the base station.

### TECHNICAL FIELD

The present application relates to network access of mobile devices. In particular, the application relates to a device and method for preventing network access by UMTS mobile devices.

### BACKGROUND

Mobile communication devices have become ubiquitous. Many mobile devices now use third-generation (3G) cell phone technologies. Universal Mobile Telecommunications System (UMTS) is one such technology which is gaining in popularity. UMTS uses Wideband Code Division Multiple Access (WCDMA) as a high speed transmission protocol to communicate with a base station.

However, a number of problems may exist with the UMTS mobile devices being present everywhere. In particular, there are a number of locations in which it is undesirable for UMTS mobile devices to be able to send or receive calls. Examples of such locations include public or private venues in which privacy and quiet may be important, e.g., libraries, laboratories, auditoriums, lecture halls, classrooms, or theatres. It may thus desirable in these locations to block the UMTS mobile devices from communicating with the base station.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts of the invention defined by the claims, and explain various principles and advantages of those embodiments.

FIG. 1 illustrates a UMTS system according to one embodiment.

FIG. 2 is a timing diagram of communication disruption in a UMTS mobile device according to one embodiment.

FIG. 3 is a flow chart of a method of disrupting communication in a UMTS mobile device according to one embodiment.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted to facilitate viewing clarity. It will further be appreciated that certain actions and/or steps may be described or depicted in a particular order of occurrence while those skilled in the art will understand that such specificity with respect to sequence is not actually required.

### DETAILED DESCRIPTION

A Universal Mobile Telecommunications System (UMTS) interference device, a UMTS system containing the UMTS interference device, and a method of interfering with communications between a UMTS mobile device and a base station are described. The UMTS interference device corrupts signals from UMTS mobile devices disposed within an area in which it is desired to block calls (or any user directed or generated content such as voice, video, instant messages, etc.) from being transmitted and/or received. To accomplish this, the UMTS interference device detects an access grant signal from a UMTS base station, which is in response to a preamble sent to the UMTS base station by the UMTS mobile device. As the UMTS standard is known, the timing, basic format and encoding of the response from the UMTS mobile device to the access grant is known. Accordingly, the UMTS interference device can easily corrupt this response, thereby preventing communication between the UMTS mobile device and the UMTS base station from being established.

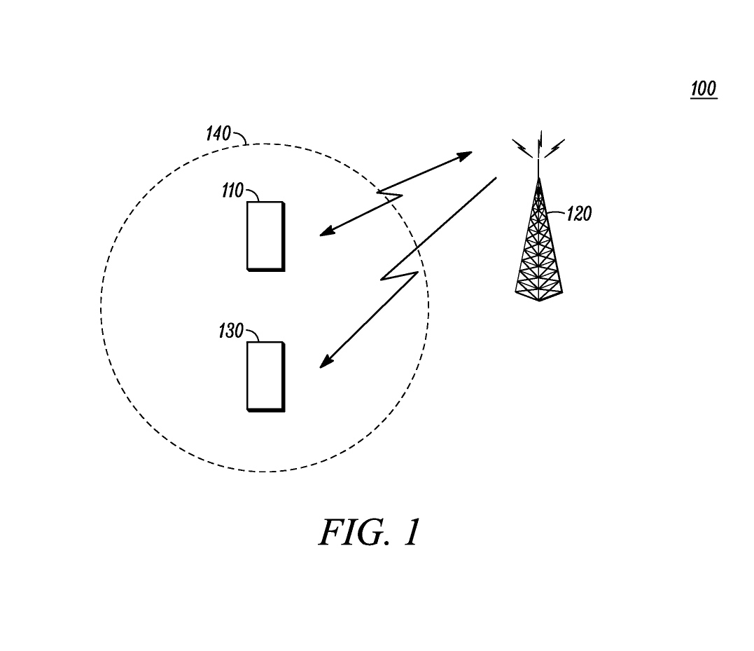

In one embodiment, an interference system 100 includes a UMTS mobile device 110, a UMTS base station 120, and an interference device 130. The mobile device 110 communicates with the base station 100 as shown in FIG. 1. The interference device 130 receives transmissions from the base station 120 directed at the mobile device 110 and provides corruption signals that are effective to disrupt communications between the mobile device 110 and the base station 120. The interference device 130 is effective to corrupt signals from any mobile device 110 within a desired area 140. The interference device 130 may be a stationary (i.e., mounted) device that remains in a stationary geographical area over which the interference is effective. Alternatively, the interference device 130 may be a mobile device in which the geographical area over which the interference is effective moves as the device moves.

Calls between the mobile device 110 and the base station 120 may be prevented by affecting one or more of the above signals between the mobile device 110 and the base station 120. Some parameters to be considered when attempting to prevent calls are the area over which the prevention is to be effective, the prevention failure rate (i.e., the percentage of calls that are not corrupted), and the amount of power required for the interference device 130 to be effective for the area and failure rate desired. In one embodiment, to be effective in a particular area, the interference device 130 is able to detect a signal transmitted from the base station 120 and received by the mobile device 110 disposed within the area and in response transmit a corruption signal to the base station 120. The corruption signal is able to prevent, within the given failure rate, the base station 120 receiving the corruption signal from determining that a response was transmitted from the mobile device 110 to the base station 120. In such an embodiment, the interference device 120 contains, among other electronic components, a receiver to receive signals at a UMTS downlink frequency, a transmitter to transmit signals at a UMTS uplink frequency, and hardware and/or software that detects and decodes the signals from the base station 120 and encodes the signals to the base station 120. The hardware may include, for example, a microprocessor, a field-programmable gate array (FPGA), an application-specific integrated circuit (ASIC), or the like.

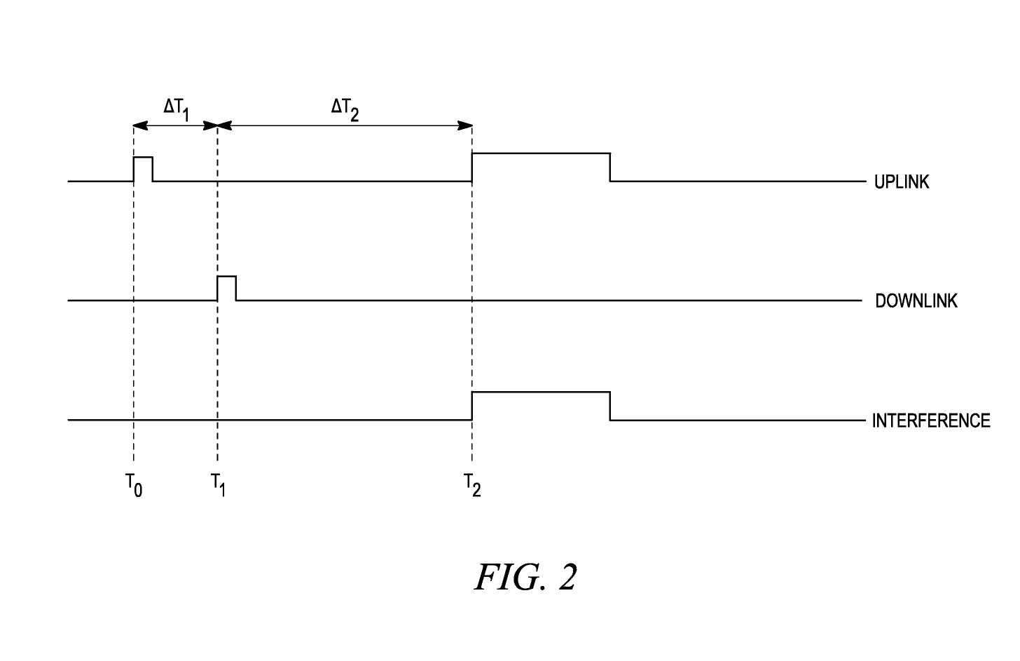

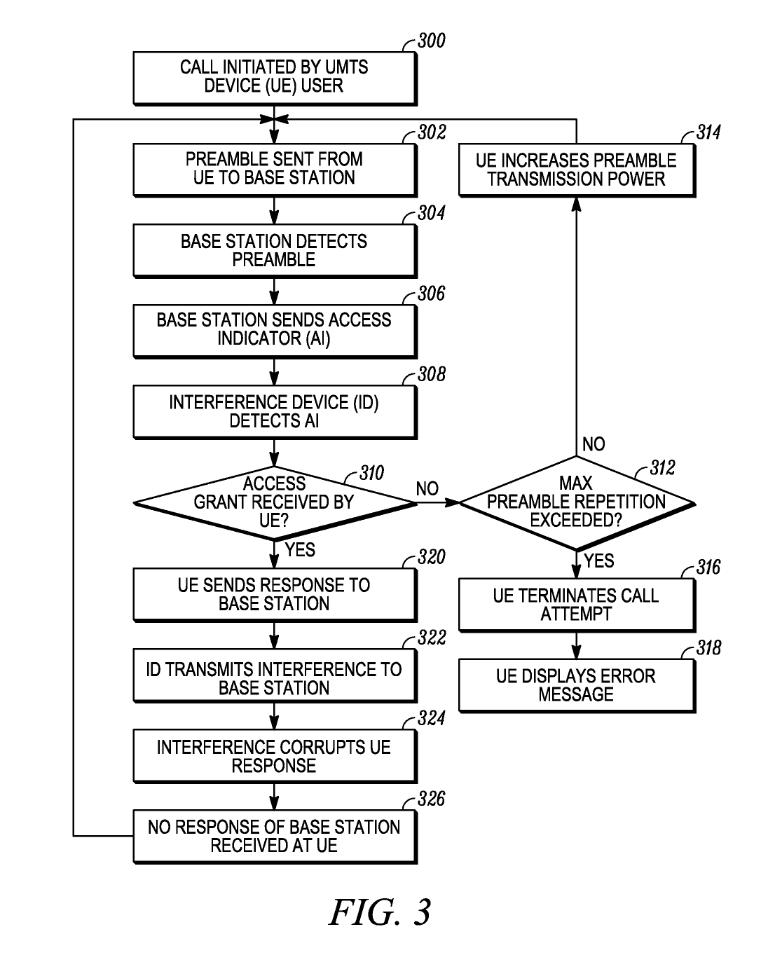

The mobile device 110 communicates with the base station 120 through the UMTS setup procedure shown in FIGS. 2 and 3. If the mobile device 110 is to receive a call, the base station 120 first sends a page (not shown) to the mobile device 110 on a Paging Channel (PCH) on a downlink frequency. The mobile device 110 then responds to the page from the base station 120 on a Random Access Channel (RACH) by sending a preamble to the base station 120 on an uplink frequency as shown at time T₀. Alternatively, if the mobile device 110 initiates the call, the process begins with the mobile device 110 sending the preamble to the base station 120 at time T₀. The base station 120 acknowledges the preamble from the mobile device 110 with an access indicator on an Access Indicator Channel (AICH) on the downlink frequency at time T₁, which is ΔT₁ after T₀. The access indicator contains an access grant or deny message. If the mobile device 110 does not receive an access indicator at the predetermined time, the mobile device 110 retransmits the preamble at increasing power at UMTS standard intervals until it either receives an access grant or deny from the base station 120 or a preset number of retransmissions is exceeded. If the mobile device 110 receives an access grant, it sends a response at the uplink frequency on the RACH. The response can contain a number of messages, depending on the configuration of the base station 120 and the reason why the mobile device 110 is communicating. An example of a common message normally used by the mobile device to establish communications between the mobile device and the base station is a Radio Resource Control (RRC) Connection Request. Other types of messages which can be sent over the RACH include direct transfers or security mode commands if the RACH is configured to support dedicated control channels, for example. Regardless of the message contents, however, the message is sent at time T₂, which is ΔT₂ after T₁. The time differences ΔT₁ and ΔT₂ are determined by the UMTS standard. In the case of a RRC Connection Request message, the network and the mobile device 110 then establish an RRC Connection and authenticate each other. Eventually the mobile device 110 indicates that information (e.g., a call or message) is being received, e.g., by ringing, and the user may answer the mobile device 110.

In one embodiment, the interference device continuously floods the desired area with high power interference at the frequency at which the mobile device and/or base station operate. However, while such a method is relatively simple, it may be impracticable if power is an issue (e.g., the interference device runs on battery power), if other non-UMTS devices in the area may be inadvertently affected, or due to the blocking being effective sufficiently far outside the area, for example.

In another embodiment, the interference device detects preambles sent by the mobile device, and then transmits a corruption message at the correct time (i.e., T₁) to override the access grant sent by the base station. However, a number of difficulties are inherent using this approach. For example, the preamble from the mobile device is initially transmitted at the lowest possible power that the base station can detect to conserve the power of the mobile device. Depending on the environment, it thus may be difficult for the interference device to detect the preamble.

Another source of problems may be the timing to detect the preamble and to generate and transmit a corruption signal to the mobile device to corrupt the access grant. If the preamble is not detected or the corruption signal does not reach the mobile device in time, the access grant from the base station will not be blocked and the call will be completed.

In addition, as mentioned above, the preamble is transmitted by the mobile device at increasing power until the base station detects it. Thus, the interference device has to react to each of these transmissions whether or not the base station detects the particular transmission from the mobile device. This leads to unnecessary transmissions of the corruption signal for the preambles that are not detected by the base station, which in turn increases power consumption of the interference device without providing any useful result. Moreover as the access grant is encoded with a simple, robust repetition code to prevent corruption of the access grant, the power consumption of the interference device is further increased relative to a signal that does not have such a robust code.

If multiple mobile devices are present in the desired area, they may each attempt to communicate with the base station at or near the same time. The multiple preambles transmitted by different mobile devices may be received differently at the base station than at the interference device. This may lead to the interference device not detecting either (or detecting only one) preamble because of a collision while the base station receives one or both correctly and responds accordingly. In this case, at least one of the access grants will not be blocked and that call will be successfully completed.

The interference device also transmits corruption signals on the same UMTS downlink frequency as the base station. The interference device is thus unable to monitor communications from the base station at the same time that it is transmitting the corruption signal. The interference device is also unable to search for other base stations that may overlap and be transmitting to the same area and respond to mobile devices in the area. Further, because the interference device transmits on the downlink, remaining synchronized with the base station is a significant challenge, increasing system complexity and power consumption. To reduce power consumption and limit the probability of false positive preamble detections, the interference device may only look for preambles at certain predetermined times based on the timing of the received downlink, which may be problematic if synchronization with the base station is not maintained. Similarly, if the interference is continuously transmitted, maintaining synchronization with the base station is at best problematic.

The above method also assumes a base station communicating with the mobile device using a single antenna. However, the system may use STTD-based (Space-Time Transmit Diversity) open loop transmit diversity, in which the base station uses multiple antennae to respond to the same preamble. This further increases the complexity of the interference device as it must take the transmission diversity into account to be effective.

Despite these potential problems, the above method may be useful in certain instances. However, an alternate embodiment whose timing diagram is shown in FIG. 2 may help to combat the above problems. In the embodiment of FIG. 2, instead of listening to the preamble from the mobile device 110 to the base station 120 on the RACH and then attempting to corrupt the access grant from the base station 120, the interference device 130 listens to the AICH for an access grant transmitted by the base station 120 at time T₁. After detecting an access grant, the interference device 130 corrupts the message transmitted in the response of the mobile device 110 at time T₂ by transmitting a corruption message on the RACH. The message from the mobile device 110 always occurs exactly 2 ms after the start of the access grant (i.e., ΔT₂=2 ms) according to the UMTS standard. Because the timing of the message, the format of the message, and the error control coding of the message are all known in advance (based on the configuration of the base station 120), an effective corruption signal from the interference device 130 can be constructed with relatively low power.

As shown in example of the flowchart of FIG. 3, a call is initiated by the user (300). The mobile device 110 transmits a preamble to the base station 120 (302). The base station 120 detects the preamble (304) and transmits an access indicator back to the mobile device (306). The interference device 130 detects the access indicator (308). If the base station 120 does not detect the preamble and thus does not send the access indicator or if the mobile device 110 otherwise does not detect the access indicator (310), the mobile device 110 determines whether the maximum number of preamble repetition transmissions has been exceeded (312). If the maximum number of preamble repetition transmissions has not been exceeded, the mobile device 110 increases the power of the preamble transmission (314) and then retransmits the preamble to the base station 120 (302). If the maximum number of preamble repetition transmissions has been exceeded, the mobile device 110 terminates the call attempt (316) and may display an error message (318).

If the mobile device 110 detects the access indicator (310), and the access indicator is determined to be an access grant, the mobile device 110 sends a response to base station 120 (320). The interference device 130, however, has also detected the access indicator and transmits a corruption signal to the base station 120 at substantially the same time (322) and on the uplink frequency as the response from the mobile device 110. The corruption signal garbles the response from the mobile device 110 so that the base station 120 (324) is unable to process the response. As the response from the mobile device 110 is sufficiently corrupted by the interference from the interference device 130, the base station 120 does not respond to the message from the mobile device 110 and a response from the base station 120 is not received by the mobile device 110 (326). As a response from the base station 120 is not forthcoming, the mobile device 110 restarts the process by retransmitting the preamble to the base station 120 and again waiting for an access indicator from the base station 120. This may or may not lead to an error message being displayed on the mobile device 110.

In the method described by the flowchart of FIG. 3, the interference device 130 transmits a signal to the base station 120 on the RACH at the uplink frequency. This permits the interference device 130 to maintain synchronization with the UMTS base station, simultaneously monitoring the UMTS control channels of the base station 120 and searching for other base stations.

The interference device 130 supports two modes of operation: continuous and limited power. In limited power mode, as described, transmissions from the interference device 130 only occur when an access indicator or access grant from the base station 120 is detected. In continuous mode, a corruption signal is continuously transmitted from the interference device 130 to interfere with any RACH responses that might be sent. Such a mode is more power intensive but be more effective in guaranteeing that a connection between the mobile device 110 and the base station 120 is not completed in the absence of the interference device 130 failing to detect an access indicator or access grant in the desired area. In either case, the power used by the interference device 130 to corrupt the response from the mobile device 110 may be less than that to corrupt the access grant from the base station 120. This is due to the reasons provided above, e.g., robust code and transmit diversity of the signals from the base station 120, as well as the power available for the mobile device 110 transmission (limited by the UMTS standard or by the base station 120) may be less than the power available for the base station 120 transmission.

To corrupt the response from the mobile device, the entire response may be corrupted or only selected bits of the response may be corrupted. As long as a specific part of the response is known in advance, even corruption of a single bit may cause the entire response to be ignored or rejected by the base station. For example, altering one bit of an error correction code in the response may cause the response to be rejected by the base station. Such an embodiment may dramatically reduce the power usage of the interference device 130 in comparison with a signal that is to overpower the entire response from the mobile device 110 (or the access grant signal from the base station 120). This is useful as the messages sent over the RACH have a standard format, and thus only selected bits of the transmitted RACH message may be corrupted by the corruption signal to garble the RACH message from the mobile device 110 at the base station 120 rather than overwhelming the entire message.

The interference device 130 may be configured to detect any access indicator or access grant from any base station that responds to the preamble and then interfere with each response from the mobile device 110. Alternatively, the interference device 130 may be configured to detect an access indicator or access grant from a particular base station and/or interfere with the response from the mobile device 110 only to a particular base station. In this embodiment, as the interference device 130 corrupts the signal from the mobile device 110 rather than the base station 120, whether the base station 120 uses transmit diversity is immaterial to the design of the interference device 130.

Although it is assumed that the mobile device 110 and the interference device 130 are disposed such that the response from the mobile device 110 and the corruption signal from the interference device 130 reach the base station 120 essentially simultaneously, this may not be the case. Multipath effects, fading, geometry of the relative distances between the mobile device 110, the base station 120, and the interference device 130, and other factors as the mobile device 110 moves within the area may cause a temporal deviation between these signals as they reach the base station 120. The interference device 130 may send a single corruption signal to the base station 120 at a time that is within a calculated range of time for the response from any mobile device within the area to reach the base station 120 directly. The calculation of the range may use the position of the stationary base station 120, the position of the interference device 130, and the stationary area in which calls are to be prevented. For example, the calculation may result in the time for that it would take a hypothetical mobile device in the center of the area to respond to the access grant from the base station 120. Alternatively, the interference device 130 may compensate for these effects by, for example, providing multiple corruption signals to the base station 120 at slightly different times, which may be within or near the calculated range.

Although it has not been discussed above, the interference device may be able to determine whether the access indicator from the base station is an access grant or access deny prior to sending out a corruption signal. In this case, the interference device need not transmit a corruption signal if an access deny is received by the mobile device, thereby reducing the power consumption of the interference device. Alternatively, the interference may transmit a corruption signal regardless of whether an access grant or deny is transmitted by the base station.

The interference device may transmit the corruption signal omni-directionally regardless of the location of any base station that services the area. Alternatively, the interference device may detect or otherwise have programmed the approximate direction of the base station and the transmission may be localized in that direction. In this latter case, if multiple base stations service the area, the interference device may determine which base station has supplied the access indicator or access grant and target that base station. If multiple base stations service the same area, the interference device may target all of the base stations without determining which particular base station provided the access indicator or access grant.

Although a single interference device has been described, multiple interference devices actively corrupt the mobile device responses within overlapping areas. The interference device(s) may use any embodiment described alone or in combination with another embodiment.

Although an interference device in which response signals from the mobile devices in the desired area are always blocked, other embodiments are possible. While merely turning off the interference device is possible, powering the interference device up and down may not be desirable. Thus, the interference device may have an internal timer that permits the interference device to automatically activate or deactivate at certain times. Alternatively or in addition, the interference device may be able to be activated and deactivated by an external wired or wireless signal supplied to the interference device.

It will be understood that the terms and expressions used herein have the ordinary meaning as is accorded to such terms and expressions with respect to their corresponding respective areas of inquiry and study except where specific meanings have otherwise been set forth herein. Further, although the singular term has been used throughout the specification to describe various features, multiples of these features are intended to be encompassed. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Those skilled in the art will recognize that a wide variety of modifications, alterations, and combinations can be made with respect to the above described embodiments without departing from the spirit and scope of the invention defined by the claims, and that such modifications, alterations, and combinations are to be viewed as being within the purview of the inventive concept. Thus, the scope of the present invention should therefore not be limited by the embodiments illustrated. This scope includes future iterations of UMTS or other protocols using similar methods for channel access.

1. A communications system comprising:
a Universal Mobile Telecommunications System (UMTS) base station receiving a preamble from a UMTS mobile device disposed within an area serviced by the base station and transmitting an access indicator to the mobile device at a downlink frequency; and
an interference device transmitting a corruption signal at an uplink frequency to interfere with a response from the mobile device to the access indicator.

2. The system of claim 1, wherein the interference device transmits a plurality of corruption signals in response to the access indicator, the corruption signals spread in time to emulate responses from the mobile device to the base station along multipath rays and to mitigate the effects of propagation delays due to unknown system geometries.

3. The system of claim 1, wherein the interference device in response to the access indicator corrupts only a portion of the response from the mobile device.

4. The system of claim 1, wherein the interference device is a stationary device.

5. The system of claim 1, wherein the interference device is a mobile device.

6. The system of claim 1, wherein, of the preamble from the mobile device, the access indicator from the base station, and the response, the corruption signal from the interference device interferes only with the response from the mobile device.

7. The system of claim 1, wherein the interference device operates only after the access indicator is detected.

8. The system of claim 1, wherein the interference device operates continuously whether or not the access indicator is detected.

9. The system of claim 1, wherein the interference device transmits the corruption signal only if the access indicator is the access grant.

10. A communications method comprising:
receiving an access indicator from a Universal Mobile Telecommunications Method (UMTS) base station at a downlink frequency, the access indictor in response to a preamble sent to the base station from a UMTS mobile device disposed within an area serviced by the base station; and
interfering with a response from the mobile device to the access indicator at an uplink frequency.

11. The method of claim 10, further comprising transmitting a plurality of corruption signals in response to the access indicator, the corruption signals spread in time to emulate responses from the mobile device to the base station along multipath rays and to mitigate the effects of propagation delays due to unknown system geometries.

12. The method of claim 10, further comprising corrupting only an RRC Connection Request of the response from the mobile device.

13. The method of claim 10, further comprising, of the preamble from the mobile device, the access indicator from the base station, and the response, interfering only with the response from the mobile device.

14. The method of claim 10, the interfering comprises interfering with the response only after the access indicator is detected.

15. The method of claim 10, wherein the interfering comprises interfering with the response only after an access grant is detected.

16. An interference device comprising:
a receiver receiving an access indicator from a Universal Mobile Telecommunications System (UMTS) base station at a downlink frequency, the grant indicator in response to a preamble from a UMTS mobile device disposed within an area serviced by the base station; and
a transmitter transmitting at an uplink frequency a corruption signal in response to the access indicator to interfere with a response from the mobile device to the access indicator.

17. The device of claim 16, wherein, of the preamble from the mobile device, the access indicator from the base station, and the response, the corruption signal interferes only with the response from the mobile device.

18. The device of claim 16, wherein the transmitter transmits the corruption signal only after the access indicator is detected.

19. The device of claim 16, wherein the transmitter transmits continuously whether or not the access indicator is detected.

20. The device of claim 16, wherein the transmitter transmits continuously only if the access indicator is an access grant.
